(19) United States
(12) Patent Application Publication
(10) Pub. No.: US 2025/0027783 A1
(43) Pub. Date: Jan. 23, 2025

(54) RECOMMENDATION METHOD

(71) Applicant: TOYOTA JIDOSHA KABUSHIKI KAISHA, Toyota-shi (JP)

(72) Inventors: Tatsuya Sonobe, Tokyo (JP); Shintaro Fukushima, Tokyo (JP); Yuya Kanehana, Nagakute-shi (JP); Jiawei Yong, Kawasaki-shi (JP)

(73) Assignee: TOYOTA JIDOSHA KABUSHIKI KAISHA, Toyota-shi (JP)

(21) Appl. No.: 18/741,769

(22) Filed: Jun. 13, 2024

(30) Foreign Application Priority Data
Jul. 18, 2023 (JP) 2023-116574

(51) Int. Cl. G01C 21/36; G06Q 10/047

(52) U.S. Cl. CPC G01C 21/3679; G06Q 10/047

(57) ABSTRACT

The recommendation method is a recommendation method of recommending a stop location to a user based on a predetermined rule. The recommendation method includes a receiving step of receiving input of feedback information indicating whether or not recommendation of a stop location is appropriate by a user, a determination step of determining whether or not feedback information satisfies an improvement condition related to a predetermined rule, and an updating step of updating a predetermined rule based on the feedback information when it is determined that the feedback information satisfies the improvement condition.

### CROSS-REFERENCE TO RELATED APPLICATION

This application claims priority to Japanese Patent Application No. 2023-116574 filed on Jul. 18, 2023, incorporated herein by reference in its entirety.

### BACKGROUND

### 1. Technical Field

The present disclosure relates to a technical field of a recommendation method for recommending a stopover location.

### 2. Description of Related Art

As this type of method, for example, there has been proposed a method for determining a proposal destination by using, as a search condition, a mental load on a user based on a movement history of the user (see Japanese Unexamined Patent Application Publication No. 2014-098623 (JP 2014-098623 A)). Other related-art documents related to the present disclosure include Japanese Unexamined Patent Application Publication Nos. 2020-052468 (JP 2020-052468 A), 2008-233033 (JP 2008-233033 A), 2019-191683 (JP 2019-191683 A), and 2020-153919 (JP 2020-153919 A).

### SUMMARY

For example, in the technology described in JP 2014-098623 A, there is no configuration that uses feedback from the user about the proposal destination. Therefore, the technology described in JP 2014-098623 A has a technical problem in that the proposal result cannot be improved even when the user determines that the proposal destination as the proposal result is not appropriate.

The present disclosure has been made in view of the above problem, and an object of the present disclosure is to provide a recommendation method that can improve a rule related to recommendation.

A recommendation method according to an aspect of the present disclosure is a recommendation method for recommending a stopover location to a user based on a predetermined rule. The recommendation method includes:
a receiving step for receiving input by the user for feedback information indicating whether recommendation of the stopover location is appropriate;
a determination step for determining whether the feedback information satisfies an improvement condition related to the predetermined rule; and an updating step for updating the predetermined rule based on the feedback information when determination is made that the feedback information satisfies the improvement condition.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a vehicle according to an embodiment;

FIG. 2 is a flowchart illustrating an operation of the navigation device according to the embodiment;

FIG. 3 is a diagram illustrating an example of a display image;

FIG. 4 is a diagram illustrating another example of a display image;

FIG. 5 is a diagram illustrating another example of the displayed images; and

FIG. 6 is a flowchart illustrating a feedback operation according to the embodiment.

### DETAILED DESCRIPTION OF EMBODIMENTS

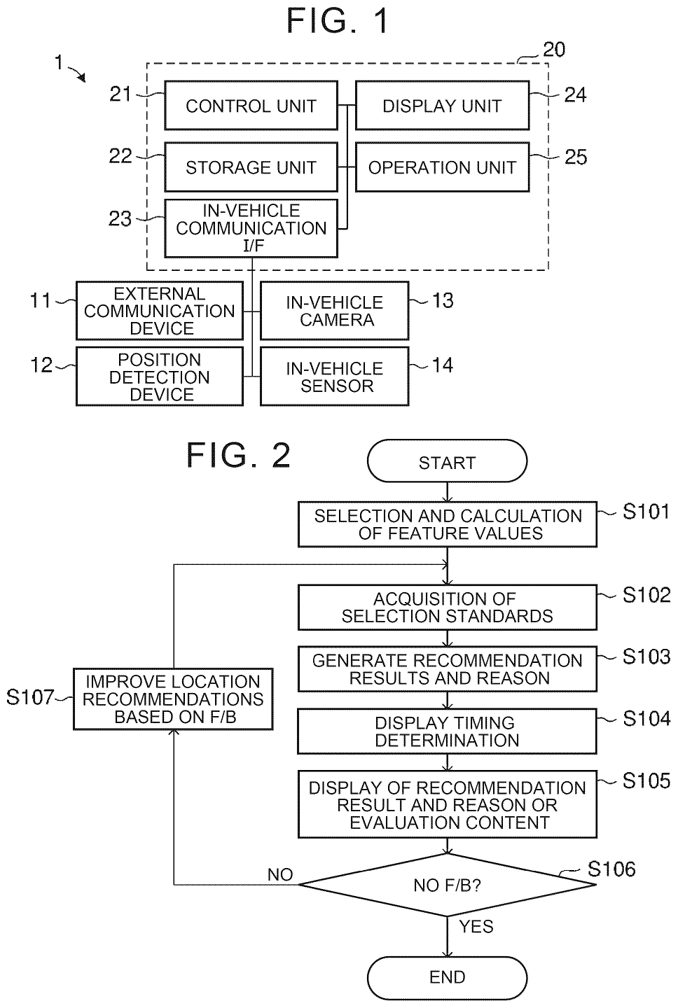

Embodiments of the recommendation methods will be described referring to FIG. 1 to FIG. 6.

### Vehicle Configuration

The configuration of the vehicles according to the embodiment will be described referring to FIG. 1. In FIG. 1, the vehicle 1 includes an external communication device 11, a position detection device 12, an in-vehicle camera 13, an in-vehicle sensor 14, and a navigation device 20. The vehicle 1 may be a vehicle having an autonomous driving function.

The external communication device 11 is a device having a wireless communication function. The external communication device 11 is connected to a network via a radio base station. The position detection device 12 is a device that detects the position of the vehicle 1. The position detection device 12 may be, for example, a Global Positioning System (GPS) receiver.

The in-vehicle camera 13 is not limited to a camera that captures an image of the surroundings of the vehicle 1 (in other words, the outside of the vehicle 1), but may be a camera that captures an image of a vehicle cabin of the vehicle 1 (in other words, the inside of the vehicle 1). The in-vehicle camera 13 may include two or more cameras. In this case, the in-vehicle camera 13 may include a camera that captures an image of the surroundings of the vehicle 1 and a camera that captures an image of the vehicle cabin of the vehicle 1. The in-vehicle sensor 14 may include, for example, at least one of a speed sensor, an acceleration sensor, a yaw rate sensor, a steering angle sensor, a temperature sensor, a humidity sensor and a rain sensor.

The navigation device 20 includes a control unit 21, a storage unit 22, and an in-vehicle communication interface (I/F) 23, a display unit 24, and an operation unit 25. The control unit 21 may include one or more processors that execute a predetermined computer program. The storage unit 22 may be a storage medium that stores a predetermined computer program to be executed by the control unit 21. The in-vehicle communication I/F 23 may be a communication interface for the navigation device 20 to communicate with other in-vehicle devices of the vehicle 1 via an in-vehicle network.

The display unit 24 may be, for example, a liquid crystal display or an organic Electro-Luminesence (organic EL) display. The operation unit 25 may be, for example, at least one of a touch panel, a mouse, a keyboard, and an operation button. Note that the display unit 24 and the operation unit 25 may be integrated as a touch display.

### Operation of the Navigation Device

The operation of the navigation device 20 will be described referring to the flow chart of FIG. 2. First, an outline of the operation of the navigation device 20 will be described. Next, the operation of the navigation device 20 will be described with reference to a specific example.

In FIG. 2, the control unit 21 of the navigation device 20 selects a feature value for recommending a stop location and calculates a weighting parameter of the selected feature value (S101). The feature amount may include, for example, at least one of a current time, a season, weather, vehicle data, road information, business hours, a site area, parking lot information, a type of a stop place, and a popularity level. The popularity may be determined based on at least one of the number of visitors and the number of visits of each person. The control unit 21 may calculate the weighting parameter by performing a predetermined filtering process on the category-type feature amount. The control unit 21 may calculate the weighting parameter by performing, for example, Laplace smoothing on the number-shaped feature amount.

Next, the control unit 21 acquires a selection criterion (S102). For example, the control unit 21 may change the selection criterion based on at least one of the type of the recommended stop place and the characteristic quantity selected in S101 process. The selection criteria may include formulas for merging features selected in S101 process. The selection criterion may include the number of stop places recommended to the user of the vehicle 1. The selection criteria may include an exclusion filter for determining a stop location to be excluded. The selection criterion may be a learning model that outputs a stop location recommended to the user when the feature amount is input. The learning model may be referred to as a recommendation model because it is used for recommendation of a stop place.

Next, the control unit 21 generates a recommendation result and a recommendation reason (S103). For example, the control unit 21 may calculate a score of each of the plurality of stop-place candidates using a calculation formula included in the selection criterion. The control unit 21 may select one or more stop locations to be recommended to the user from the plurality of stop locations candidates based on the calculated score. The control unit 21 may generate information indicating the selected one or more stop locations as the recommendation result. For example, the control unit 21 may extract one or more feature amounts having a large influence on the score from among the plurality of feature amounts related to the selected one or more stop locations. The control unit 21 may generate the recommendation reason based on the extracted one or more feature amounts.

The control unit 21 determines the timing of displaying the recommendation result and the reason for the recommendation (S104). Note that S104 process may be performed in parallel with S101 to S103 processes. For example, the control unit 21 may determine a timing at which the travel of the vehicle 1 is not affected as a display timing. The timing at which the travel of the vehicle 1 is not affected may include at least one of when the position of the shift lever is “P” and when the vehicle 1 is stopped.

The control unit 21 controls the display unit 24 so that the recommendation result and the reason for the recommendation are displayed at the display timing determined in S104 process (S105). In addition, the control unit 21 controls the display unit 24 so that the evaluation content is displayed. The “evaluation content” may mean an evaluation item of the user with respect to the recommendation result. A specific example of the “recommendation result and reason for recommendation” and the “evaluation content” will be described later. Note that the display timing of the “recommendation result and the reason for recommendation” and the display timing of the “evaluation content” may be different or the same.

The control unit 21 determines the presence or absence of feedback from the user (S106). In S106 process, when it is determined that there is no feedback from the user (S106: Yes), the operation shown in FIG. 2 is ended. S101 process may be performed after the first predetermined period has elapsed since the operation shown in FIG. 2 ended. That is, the operation shown in FIG. 2 may be repeated at a cycle corresponding to the first predetermined period.

In S106 process, when it is determined that there is feedback from the user (S106: Yes), the control unit 21 improves the recommendation logic related to the stop location based on the feedback (S107). A specific example of a method for improving the recommendation logic will be described later. It should be noted that improving the recommendation logic may mean improving at least a portion of the selection criteria described above.

### First Embodiment

As a first specific example of the operation of the navigation device 20, an operation of recommending a stop place for spending leisure will be described referring to FIG. 2 and FIG. 3 to FIG. 6. At least one of a restaurant and a tourist spot may be included in the stop place for spending the leisure.

For example, the control unit 21 may acquire visit history data of at least one of the restaurant and the tourist spot of the user of the vehicle 1. For example, the control unit 21 may acquire visit history data of at least one of a restaurant and a tourist spot of another person (that is, a person different from the user of the vehicle 1).

In S101 process of FIG. 2, the control unit 21 may select, as the characteristic quantity, at least one of the genre of the restaurant visited by the user (for example, Japanese food, Western food, Chinese food, etc.) and the genre of the tourist spot visited by the user (for example, natural, leisure facilities, historic buildings, etc.) based on the visit history data of the user of the vehicle 1. Based on the visit history data of the user of the vehicle 1, the control unit 21 may select, as the feature amount, a transition between locations indicating that the user has visited another location after visiting one location. The control unit 21 may select, as the feature amount, at least one of the number of visitors to one restaurant and the number of visitors to one tourist spot based on the visit history data of the other person. The control unit 21 may select, as the feature amount, a transition between locations indicating that another person has visited another location after visiting one location, based on the visit history data of the other person. The control unit 21 may select at least one of the current time, the season, the weather, the vehicle data, the road information, the business hours, the site area, and the parking lot information as the feature quantity.

For example, when the visit history data of the user of the vehicle 1 does not include a situation that matches or is similar to the present situation of the vehicle 1 (for example, a traveling position, a time-zone, weather, or the like), the control unit 21 may not use the visit history data of the user of the vehicle 1 in S101 process.

In S102 process of FIG. 2, the control unit 21 may acquire, for example, a mathematical expression “recommendation score=x1×α+x2×β+ . . . ” as a selection criterion. In the above equation, “x1, x2, . . . ” represents a characteristic quantity, and “α, β, . . . ” represents a parameter (for example, a weighting parameter). The above formula corresponds to an exemplary formula for merging the features selected in S101 process. In S102 process, the control unit 21 may acquire, for example, exclusion filters such as “exclusion of outdoor facilities when rain occurs” and “exclusion of facilities outside business hours” as selection criteria.

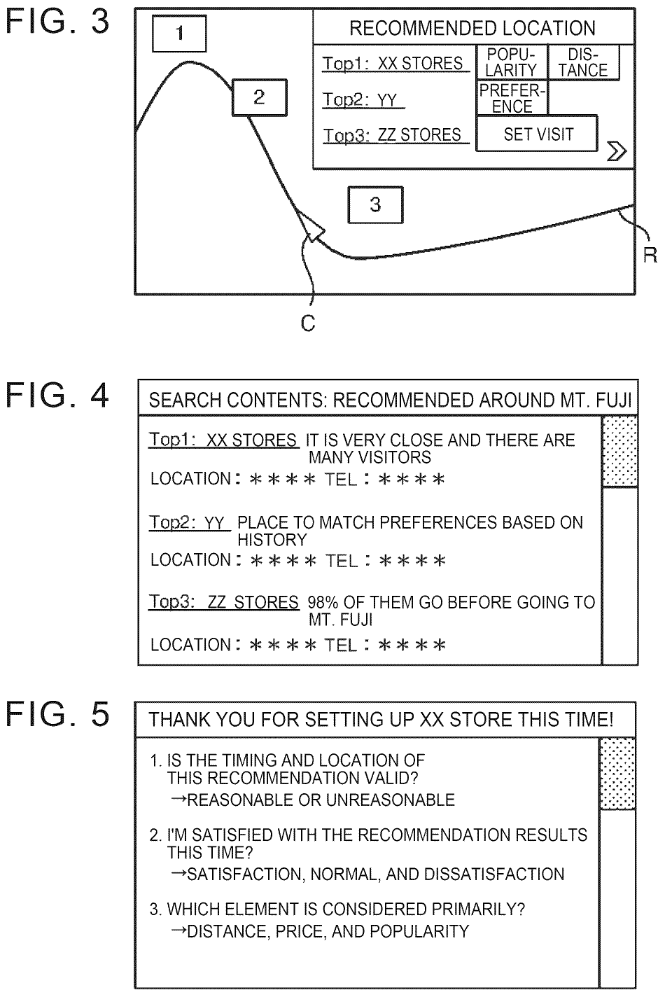

In S105 process of FIG. 2, the control unit 21 controls the display unit 24 so that the recommendation result and the reason for the recommendation are displayed. In this instance, the display unit 24 may display images as shown in FIG. 3, for example. In FIG. 3, the triangle C indicates the vehicle 1, and the solid line R indicates the road on which the vehicle 1 is traveling. The “recommended location” described in the upper-right of FIG. 3 is an exemplary recommendation outcome and a reason for the recommendation. In FIG. 3, the square encircling numbers around the solid line R correspond to the positions of the recommended locations “Top1”, “Top2”, and “Top3”. The “popularity”, “distance”, “preference” and “set visit” included in the recommended place correspond to an example of the reason for the recommendation. As shown in FIG. 3, the control unit 21 may control the display unit 24 so that the recommendation result and the reason for the recommendation are displayed on the images for performing the route guidance. The method of displaying the recommendation result and the reason for the recommendation as shown in FIG. 3 may be referred to as a push-type notification method.

Alternatively, in S105 process, the display unit 24 may display images as shown in FIG. 4, for example. For example, when the operation shown in FIG. 2 is performed due to the user of the vehicle 1 inputting “recommendation around Mt. Fuji” using the operation unit 25, the display unit 24 may display images as shown in FIG. 4. The method of displaying the recommendation result and the reason for the recommendation as shown in FIG. 4 may be referred to as a pull-type notification method. For example, when the user of the vehicle 1 searches for a location using the operation unit 25, the control unit 21 may control the display unit 24 to display the recommendation result and the reason for the recommendation by a pull-type notification method. For example, when the user of the vehicle 1 does not set the destination in the navigation device 20, the control unit 21 may control the display unit 24 to display the recommendation result and the reason for the recommendation by a push-type notification method.

In S105 process, after the recommendation result and the reason for the recommendation are displayed, the control unit 21 may control the display unit 24 so that the evaluation content is displayed. For example, when the user of the vehicle 1 selects the “Top1: XX shop” shown in FIG. 3 or FIG. 4, the display unit 24 may display images for questionnairing as shown in FIG. 5. “1. Is the timing and location of this recommendation valid?”, “2. I'm satisfied with the recommendation results this time?”, and “3. Which element is considered primarily?” in FIG. 5 corresponds to an example of the evaluation content. The control unit 21, by the time the second predetermined time has elapsed after the recommendation result and recommendation reason are displayed, when the user of the vehicle 1 does not operate the operation unit 25 (in other words, when the user does not react to the recommendation result), the control unit 21 may also control the display unit 24 so that the evaluation content is displayed.

For example, when the user of the vehicle 1 answers the questionnaire using the operation unit 25 after the images shown in FIG. 5 are displayed, the control unit 21 may determine that the user is fed back in S106 process of FIG. 2. On the other hand, when the user does not answer the questionnaire, in 5106 process, the control unit 21 may determine that there is no feedback from the user.

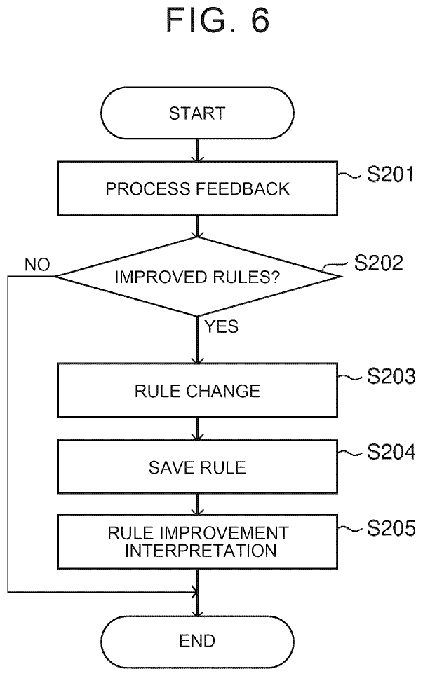

An exemplary process of S107 of FIG. 2 will be described referring to the flow chart of FIG. 6. Here, an exemplary process of S107 when the selection criterion is a learning-model will be described. In S107 process, the control unit 21 may improve the recommendation logic by performing reinforcement learning of the learning model using, for example, Reinforcement Learning from Human Feedback (RLHF).

In FIG. 6, the control unit 21 processes the feedback of the user of the vehicle 1 (for example, the answer of the questionnaire described in FIG. 5) (S201). For example, the control unit 21 may generate a policy function for adjusting a parameter (for example, a weighting parameter) related to the feature amount based on the feedback from the user.

Next, the control unit 21 determines whether or not to improve the rules related to the recommendation logic (S202). For example, the control unit 21 may obtain the variation range of the satisfaction level of the user of the vehicle 1 from the satisfaction level based on the previous feedback and the satisfaction level based on the current feedback. When the change width of the satisfaction degree is larger than the predetermined threshold value, the control unit 21 may determine not to improve the rule. On the other hand, when the variation range of the satisfaction level is smaller than the predetermined threshold value, the control unit 21 may determine that the rule is to be improved. If there is no previous feedback, the change range of the user's satisfaction level may be obtained from the initial value related to the satisfaction level and the satisfaction level based on the current feedback. Since the rule is improved when the change width of the satisfaction degree is larger than the threshold value, the change width of the satisfaction degree larger than the threshold value may be referred to as an improvement condition.

In S202 process, when it is determined that the rule is not to be improved (S202: No), for example, the control unit 21 stores the policy function generated in S201 process and ends the process shown in FIG. 6 (in other words, the process of S107 of FIG. 2 ends).

When it is determined in S202 process that the rule is to be improved (S202: Yes), the control unit 21 changes the rule based on the policy-function generated in S201 process (S203). The control unit 21 may obtain a correspondence relationship between a change in a parameter related to a rule (for example, a parameter related to a feature amount) and a change in a user's satisfaction level. The control unit 21 may change the rule by estimating a parameter such that the variation range of the user's satisfaction level exceeds a predetermined threshold based on the determined correspondence relationship.

A specific embodiment of S203 process will be described below. A learning model used to generate a recommendation result and a recommendation reason in S103 process of FIG. 2 is assumed to be an early learning model. The control unit 21 may generate the tuned learning model based on the strategy function and the initial learning model. For example, the control unit 21 may generate a training model tuned using Proximal Policy Optimization (PPO) or Trust Region Policy Optimization (TRPO).

For example, the control unit 21 may enter the features selected in S101 process of FIG. 2 into the early learning model and the tuned learning model. The control unit 21 may obtain one reward value by inputting the output result of the tuned learning model to a predetermined reward function. The control unit 21 may determine a penalty corresponding to a difference between an output result of the initial learning model and an output result of the tuned learning model. The control unit 21 may correct the one reward value using a penalty. The control unit 21 may change the policy-function generated in S201 process using the corrected one reward-value. The policy function may correspond to an example of a rule related to the recommendation logic. Improving the recommendation logic may mean changing the strategy function.

After S203 process, the control unit 21 stores the changed rule (for example, the changed policy function described above) in the storage unit 22 (S204). In parallel with S204 process, the control unit 21 may control the display unit 24 such that the changed rule is presented to the user of the vehicle 1 (S205). In this case, the control unit 21 changes the changed rule (for example, the changed policy function described above) to a mode that can be understood by the user. A user-understandable aspect may include, for example, a graph showing the effect of a stochastic gradient descent (e.g., how values of an objective function converge). A user-understandable aspect may include, for example, a description describing the modified rule. Note that S205 process may be performed only when the user has requested the process using the operation unit 25, for example.

### Secondary Embodiment

As a second embodiment of the operation of the navigation device 20, the operation of recommending a stop place capable of taking a rest will be described referring to FIG. 2. Note that the description of the second specific example that overlaps with the description of the first specific example described above will be omitted as appropriate.

For example, the control unit 21 may acquire driving history data of the user of the vehicle 1. The control unit 21 may acquire at least one of data indicating the behavior of the vehicle 1 and data indicating the state of the user of the vehicle 1. In S101 process of FIG. 2, the control unit 21 may select the driving time and the stopping timing of the user as the characteristic amounts from the acquired driving history data. The control unit 21 may select information indicating the driving state of the user (for example, the number of times of sudden braking, the number of times of sudden acceleration, the number of times of missing extension, and the like) as the feature amount from at least one of data indicating the behavior of the vehicle 1 and data indicating the state of the user of the vehicle 1. The control unit 21 may select information (for example, road information, weather, and the like) related to the external environment of the vehicle 1 as the feature amount. The control unit 21 may select attribute data (for example, presence or absence of a toilet, presence or absence of a parking lot, or the like) related to a place where the user of the vehicle 1 can take a rest as a feature amount. The control unit 21 may select at least one of a destination set in the navigation device 20, a required time to the destination, and a position of the vehicle 1 at a certain time as a feature amount.

In S102 process of FIG. 2, the control unit 21 may acquire, for example, a mathematical expression “recommendation score=x1×α+x2×β+ . . . ” as a selection criterion. In S102 process, the control unit 21 may acquire, as a selection criterion, an exclusion filter such as “exclusion of a facility that is not suitable for a short break” or “exclusion of a facility that is not suitable for a long break”, for example.

For example, the control unit 21 may estimate the rest timing of the user on the basis of at least one of the driving history data of the user of the vehicle 1, the destination set in the navigation device 20, the road information (for example, the traffic jam information, the construction information, and the like), and the position of the stop place where the rest is possible. The control unit 21 may include the estimated rest timing in the selection criterion.

Reasons for recommendation generated in S103 process of FIG. 2 may include, for example, at least one of “near”, “with toilet”, “eatable”, “smokable”, “sleepable”, and “able to lodge”.

### Third Embodiment

As a third embodiment of the operation of the navigation device 20, an operation of recommending a stop place capable of maintenance of vehicles will be described referring to FIG. 2. Note that the description of the third specific example that overlaps with the description of the first specific example described above will be omitted as appropriate.

In S101 process of FIG. 2, the control unit 21 may select the components of the vehicle 1 as the characteristic quantities. The data related to the component is not limited to the data directly indicating the state of the component, and may be data indirectly indicating the state of the component. For example, the state of the engine may be indicated as the temperature of the coolant that cools the engine. The data relating to the consumable parts may be represented by the travel distance of the vehicle 1, or may be represented by the elapsed time from the time of the last replacement.

The control unit 21 may acquire at least one of the vehicle inspection history data, the car washing history data, and the maintenance history data of the vehicle 1. The control unit 21 may select the vehicle inspection date and time and the vehicle inspection place as feature amounts based on the vehicle inspection history data. The control unit 21 may select the car washing date and time and the car washing place as feature values based on the car washing history data. The control unit 21 may select the maintenance date and time and the maintenance place as the feature quantities based on the maintenance history data.

In 5102 process of FIG. 2, the control unit 21 may acquire, for example, a mathematical expression “recommendation score=x1×α+x2×β+ . . . ” as a selection criterion. In 5102 process, the control unit 21 may acquire, for example, exclusion filters such as “exclude facilities not suitable for vehicle maintenance” as selection criteria.

In parallel with S101 and S102 processes in FIG. 2, the control unit 21 may perform anomaly detection of the components of the vehicle 1. For example, the control unit 21 may perform anomaly detection of a component of the vehicle 1 using One Class Support Vector Machine. For example, the control unit 21 may classify the abnormality degree indicating the degree of abnormality as “high”, “medium”, or “low” according to the number of abnormality data.

The reason for recommendation generated in S103 process of FIG. 2 may include, for example, at least one of “near-field”, “frequently used”, and “highly evaluated”. In S105 process of FIG. 2, the control unit 21 may control the display unit 24 so that the display mode of the recommendation changes according to the degree of anomaly. For example, in a case where the abnormality degree is “high”, the control unit 21 may control the display unit 24 so that a stop place capable of vehicle maintenance is displayed together with a message “Request an emergency response”. For example, in a case where the abnormality degree is “medium”, the control unit 21 may control the display unit 24 so that a stop place capable of vehicle maintenance is displayed together with the message “attention calling information”.

### Technical Effect

In the navigation device 20, when there is feedback from the user of the vehicle 1, the rule related to the recommendation logic is improved. Therefore, according to the recommendation method of the stop place by the navigation device 20, it is possible to improve the rule related to the recommendation logic. As a result, it is possible to recommend a more appropriate stop place.

Aspects of the disclosure derived from the above-described embodiments are described below.

A recommendation method according to an aspect of the present disclosure is a recommendation method for recommending a stop location to a user based on a predetermined rule, the method comprising: a receiving step of receiving, by the user, input of feedback information indicating whether or not recommendation of a stop location is appropriate; a determination step of determining whether or not the feedback information satisfies an improvement condition according to the predetermined rule; and an updating step of updating the predetermined rule based on the feedback information when it is determined that the feedback information satisfies the improvement condition.

In the above-described embodiment, for example, displaying the images for the questionnaire survey shown in FIG. 5 corresponds to an example of the receiving step, the process of S202 of FIG. 6 corresponds to an example of the determination step, and the process of S203 of FIG. 6 corresponds to an example of the updating step.

The recommendation method may include a rule presenting step of presenting a rule updated in the updating step to the user. In the above-described embodiment, the process of S205 of FIG. 6 corresponds to an exemplary presentation process.

The recommendation method may include a reason presenting step of presenting a reason for recommendation of the stop location to the user. In the above-described embodiment, the process of S105 of FIG. 2 corresponds to an exemplary reason presenting step.

In the recommendation method, the user may be on the vehicle, and the recommended stop location may be presented to the user at a timing that does not affect the travel of the vehicle.

The present disclosure is not limited to the above-described embodiments, and can be modified as appropriate within the scope and spirit of the disclosure that can be read from the claims and the entire specification, and a recommendation method accompanied by such a modification is also included in the technical scope of the present disclosure.

What is claimed is:

1. A recommendation method for recommending a stopover location to a user based on a predetermined rule, the recommendation method comprising:
a receiving step for receiving input by the user for feedback information indicating whether recommendation of the stopover location is appropriate;
a determination step for determining whether the feedback information satisfies an improvement condition related to the predetermined rule; and
an updating step for updating the predetermined rule based on the feedback information when determination is made that the feedback information satisfies the improvement condition.

2. The recommendation method according to claim 1, further comprising a rule presenting step for presenting the rule updated in the updating step to the user.

3. The recommendation method according to claim 1, further comprising a reason presenting step for presenting a reason for the recommendation of the stopover location to the user.

4. The recommendation method according to claim 1, wherein:
the user is in a vehicle; and
the recommended stopover location is presented to the user at a timing that does not affect travel of the vehicle.
